(19) United States
(12) Patent Application Publication
(10) Pub. No.: US 2008/0159309 A1
(43) Pub. Date: Jul. 3, 2008

(54) System and method of mapping between local and global service instance identifiers in provider networks

(75) Inventors: Robert Sultan, Somers, NY (US); Linda Dunbar, Plano, TX (US)

Correspondence Address: CONLEY ROSE, P.C., 5601 GRANITE PARKWAY, SUITE 750, PLANO, TX, 75024, US

(73) Assignee: Huawei Technologies Co., Inc. (USA), Plano, TX (US)

(21) Appl. No.: 11/728,878

(22) Filed: Mar. 27, 2007

Related U.S. Application Data
(63) Continuation-in-part of application No. 11/618,296, filed on Dec. 29, 2006.

(51) Int. Cl. H04L 12/56

(52) U.S. Cl. 370/401

(57) ABSTRACT

A method of using a domain-global Service Instance identifier at the boundaries between networks is disclosed. The method performs Service VLAN identifier to Service Instance identifier mapping function within a provider bridge when transmitting a service instance across a provider network.

### CROSS REFERENCE TO RELATED APPLICATION

The application is a continuation-in-part of prior U.S. nonprovisional patent application Ser. No. 11/618,296, filed on Dec. 29, 2006, entitled “SYSTEM AND METHOD OF MAPPING BETWEEN LOCAL AND GLOBAL SERVICE INSTANCE IDENTIFIERS IN PROVIDER NETWORKS”, by Robert Sultan.

### TECHNICAL FIELD OF THE INVENTION

The present invention relates generally to communications, and more particularly, to a versatile system and method for mapping between local and global service instance identifiers in service provider networks.

### BACKGROUND OF THE INVENTION

Traditional routing and packet switching addressed the requirements of transferring data over a network. Initially, simple software-based router platforms with network interfaces to support T1/E1- or T3/E3-based backbones were sufficient to carry out the requirements of network applications. As the demand for higher speed and the ability to support higher-bandwidth transmission rates emerged, devices with capabilities to switch at Layer-2 and Layer-3 in hardware had to be deployed. Layer-2 switching devices addressed the switching bottlenecks within subnets of a local area network (LAN) environment. Layer-3 switching devices helped alleviate the bottleneck in Layer-3 routing by moving the route lookup for Layer-3 forwarding to high-speed switching hardware.

Multiprotocol Label Switching (MPLS) is an Internet Engineering Task Force (IETF)-specified framework that provides for the efficient designation, routing, forwarding, and switching of traffic flows through the network. In an MPLS network, incoming packets are assigned a “label” by a “label edge router (LER)”. Packets are forwarded along a “label switch path (LSP)” where each “label switch router (LSR)” makes forwarding decisions based solely on the contents of the label. At each hop, the LSR strips off the existing label and applies a new label which tells the next hop how to forward the packet.

LSPs are established by network operators for a variety of purposes, such as to guarantee a certain level of performance, to route around network congestion, or to create IP tunnels for network-based virtual private networks. In many ways, LSPs are no different than circuit-switched paths in Asynchronous Transfer Mode (ATM) or Frame Relay networks, except that they are not dependent on a particular Layer-2 technology.

An LSP can be established using MPLS that crosses multiple Layer-2 transports such as ATM, Frame Relay or Ethernet. Thus, one of the true promises of MPLS is the ability to create end-to-end circuits, with specific performance characteristics, across any type of transport medium, eliminating the need for overlay networks or Layer-2 only control mechanisms.

Another benefit that MPLS brings to the IP-based networks is “Layer-2 Transport”. New standards being defined by IETF working groups allow service providers to carry Layer-2 services including Ethernet, Frame Relay and ATM over an IP/MPLS core.

Recently, an internet draft was published by Martini et al draft-martini-(12circut-trans-mpls-16 by Luca Martini, Steve Vogelsang, Daniel Tappan, Vasiel Fadoaca, Dimitri Stratton Vlachos, Andrew Malis, Chris Liljenstolpe, Dave Cooper, Giles Heron, and Kireeti Kompella, February 2005). The draft describes a method to carry Layer-2 protocol frames over an MPLS network. This method supports transport of the following types of Layer-2 frames: Frame Relay, ATM, Ethernet, Ethernet Virtual Local Area Network (VLAN), Point-to-Point Protocol (PPP), and High-Level Data Link Control (HDLC). This internet draft also describes point-to-point transport for carrying Layer-2 protocol frames and specifies the necessary label distribution procedures using different encapsulation methods depending on the types of Layer-2 frames.

### BRIEF SUMMARY OF THE INVENTION

The present invention discloses a novel method of global Service Instance (SI) mapping at network boundaries within a service provider domain. An SI is assigned an SI identifier (ISID) unique within the provider domain. Traffic at network boundaries is transported using the global SI identifier. Because traffic crossing a network boundary carries the ISID, the network is not required to have knowledge of local identifier values used by other networks within the provider domain.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 shows a traditional routing example;

FIG. 2 describes an MPLS method;

FIG. 3 shows an MPLS header within a packet;

FIG. 4 shows an MPLS traffic engineering example;

FIG. 5 illustrates an MPLS routing functionality;

FIG. 6 shows a diagram of an S-tagged service interface to a PBN;

FIG. 7 illustrates an example for the architecture of a PBN connected to a PBBN;

FIG. 8 describes a flow scheme for the SVID/ISID mapping function, MAC encapsulation and de-encapsulation within the PBBN;

FIG. 9 shows an SI mapping process at network boundaries;

FIG. 10 shows a schematic view for the interconnection of a PBN across an PBBN;

FIG. 11 shows a schematic view of directly interconnected provider networks;

FIG. 12 shows a schematic view for the interconnection of PBN networks across PBBN networks and implementation of the Connectivity Fault Management system at network boundaries;

FIG. 13 is a block diagram describing the SVID/ISID mapping function within a Provider Bridge of a PBN and multiplexing within a PBBN; and

FIG. 14 is a block diagram describing the SVID/ISID mapping function within a Provider Bridge of a PBN and the ISID/VC mapping function within a PBBN.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

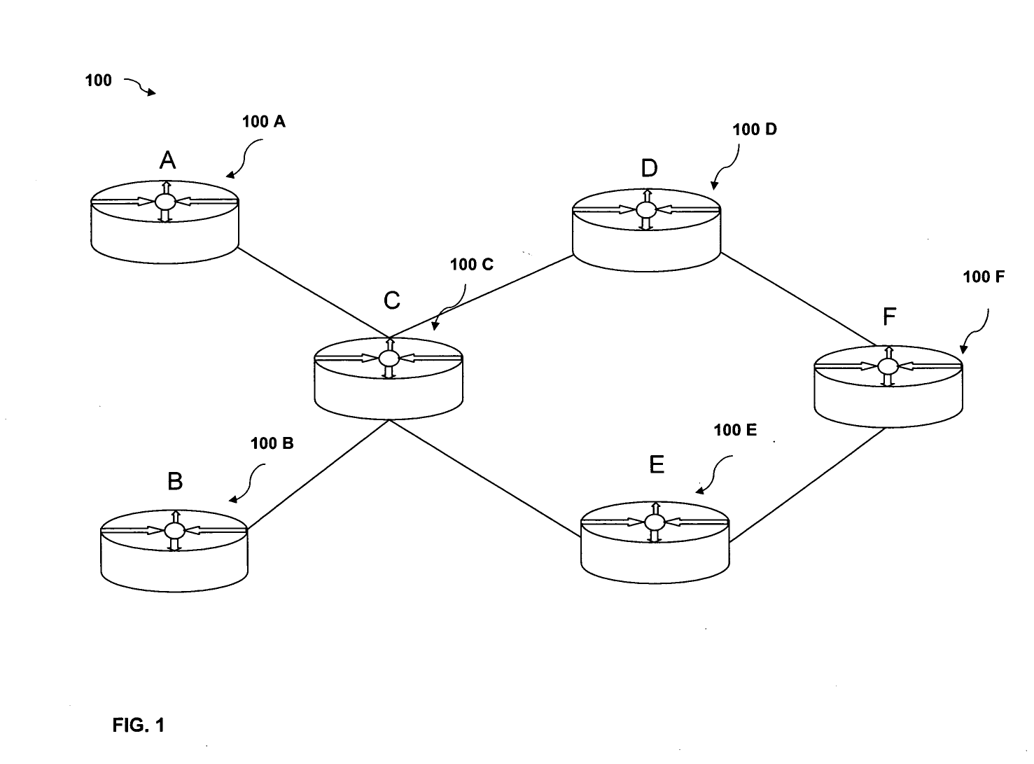

Now referring to FIG. 1, a traditional routing example is shown. In traditional routing environments, a packet is forwarded through a network on a hop-by-hop basis using interior or exterior gateway protocols. This is done by referencing the destination Layer-3 addresses against a routing table for a next hop entry. As shown in FIG. 1, 100A, 100B, 100C, 100D, 100E, and 100F are routers in a network. When Router C 100C receives a packet from a connecting router (Router A 100A, Router B 100B, Router C 100C, or Router D 100D), Router C 100C must do a route lookup, based on that destination Layer-3 address in the IP header. This must be performed to determine the packet's next hop in its path to get the packet to its final destination. The Layer-2 destination address is then replaced with the address of the address of next hop's Layer-2 address, and the source Layer-2 address of Router C 100C, leaving the source and destination Layer-3 addresses in place for the next hop to perform its own route lookup on the packet. This process must be repeated at each hop to deliver the packet to its final destination. In FIG. 1, to forward packets to Router F 100F, Router C 100C will reference only the destination address of Router F 100F. Router C 100C will then determine the best route based on the attributes that are defined in the routing protocol.

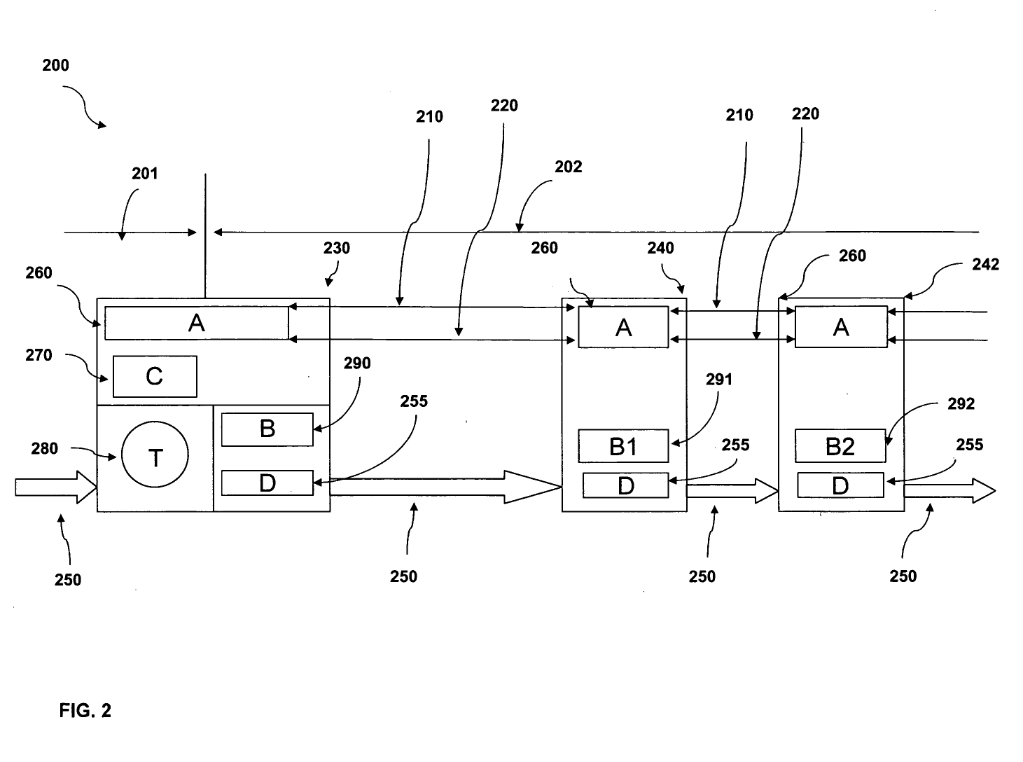

Now referring to FIG. 2, an MPLS method is illustrated. In contrast to the traditional routing method shown in FIG. 1, MPLS is a method of forwarding packets at a high rate of speed. MPLS combines the speed and performance of Layer-2 switching with the scalability and IP intelligence of Layer-3. In FIG. 2, an MPLS network 200 includes an Edge 201 and a Core 202. An LER 230 lies on the Edge 201 and an LSR1 240 and an LSR2 242 lie inside the Core 202. The LER 230 includes an IP control component 260, an IP forwarding component 270, Layer-2 transport component 280, Initial MPLS label assignment 290, and Client Data 255. Multilayer switching is achieved by having separated IP control component 260 and IP forwarding component 270. When packets 250 arrive to the LER 230, the IP forwarding component 270 searches the forwarding table maintained by the IP control component 260 to make a routing decision for each packet. Specifically, the IP forwarding component 270 examines information contained in the packet's header, searches the forwarding table for a match, and directs the packet 250 from the input interface to the output interface across the LER 230. The IP control component 260 constantly communicates with the IP forwarding component 270 by managing the packet forwarding table within the IP control component 260. More importantly, the LER 230 initiates the assignment of an MPLS label 290 for the establishment of an label-switched path (LSP). When the packets 250 are forwarded to LSR1 240 using standard IP routing protocol 210 and standard IP signaling and label-distribution protocols 220, an MPLS label swapping function 291 is performed for the establishment of another LSP, which in turn forwards packets 250 to LSR2 242.

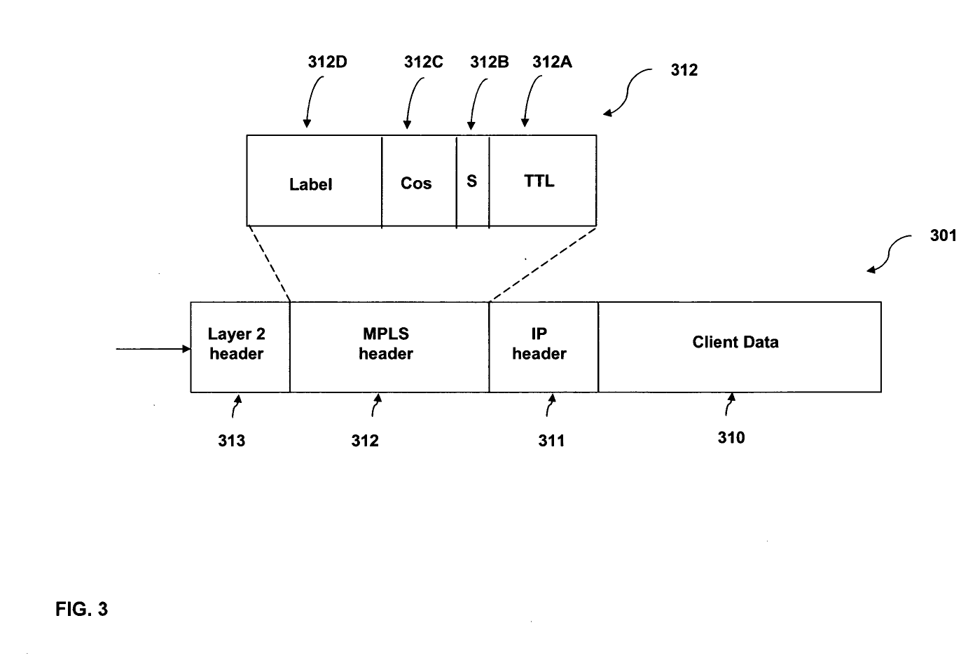

Referring now to FIG. 3, an MPLS header within a packet is shown. The MPLS forwarding component is based on the label-swapping algorithm as shown in FIG. 2. When a Layer-2 technology does not support a label field, the MPLS label 301 is encapsulated in a standardized MPLS header 312 that is inserted between the Layer-2 header 313 and the IP header. The MPLS header 312 permits any Link Layer technology to carry a MPLS label 301 so it can benefit from label-swapping across an LSP. This figure also shows a standardized 32 bit MPLS header 312. The MPLS header 312 contains the following fields: a label field 312D (20-bits) which carries the actual value of the MPLS label; a Class of Service (CoS) field 312C (3-bits) that can affect the queuing and discard algorithms applied to the packet as the packet is transmitted through the network; a Stack (S) field 312B (1-bit) that supports a hierarchical label stack; and a Time-to-Live (TTL) field 312A (8-bits) that provides conventional IP TTL functionality.

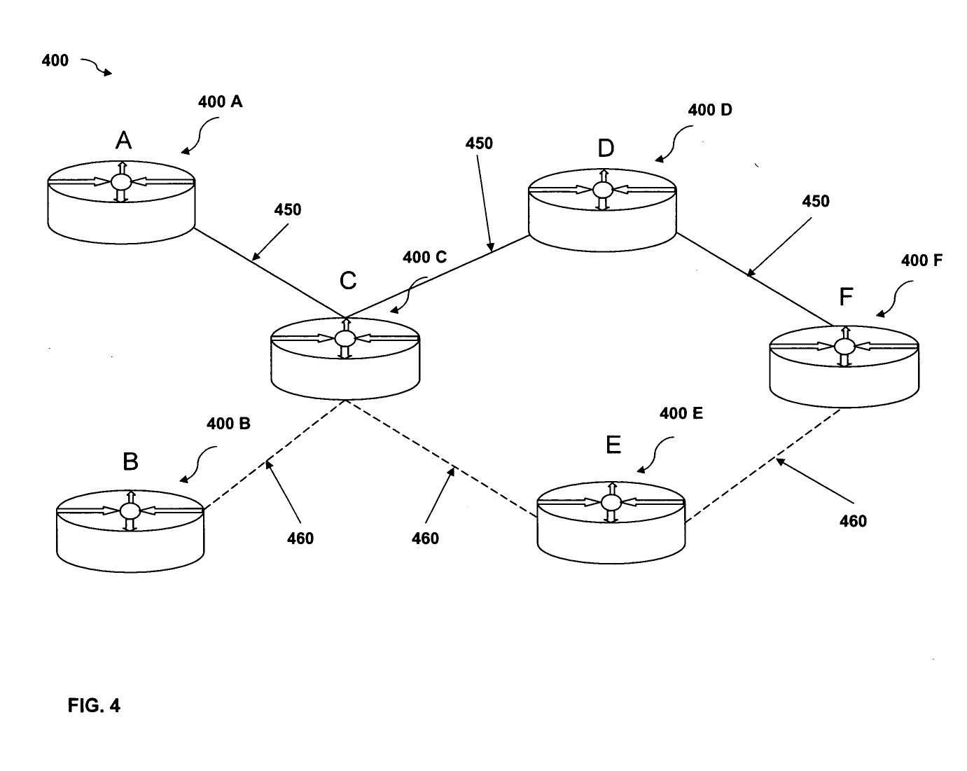

Now referring to FIG. 4, an MPLS traffic engineering example is illustrated. The figure shows a network 400 that includes Router A 400A, Router B 400B, Router C 400C, Router D 400D, Router E 400E, and Router F 400F. In this example, when MPLS is implemented as explained in FIGS. 2 and 3, a packet's path 450 (or 460) through the network 400 can be granularly controlled. For example, packets destined to Router F 400F starting from Router A 400A follow Path 450. However, packets starting from Router B 400B follow Path 460 to reach to Router F 400F. The MPLS traffic engineering provides many benefits by controlling traffic patterns.

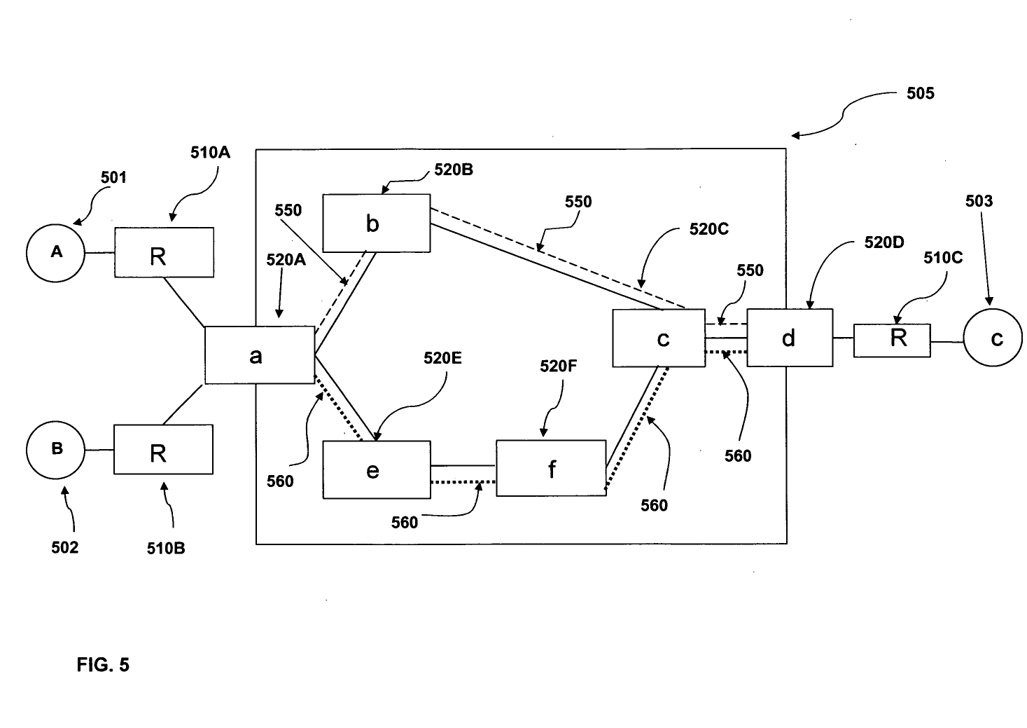

Now referring to FIG. 5, MPLS routing functionality is illustrated. The figure shows Customer A 501 and Customer B 502 on one end of a network core 505 and Customer C 503 on the other end of the network core 505. Customer A 501 is connected to Edge Router A 520A through Router 510A, Customer B 502 is connected to the Edge Router A 520A through Router 510B, and Customer C 503 is connected to the Edge Router D 520D through Router 510C. Within the network core 505, Path 550 connects Edge Router A 520A and Edge Router D 520D through Edge Router B 520B and Edge Router C 520C. Path 560 connects Edge Router A 520A and Edge Router D 520D through Edge Router E 520E, Edge Router F 520F and Edge Router C 520C.

This figure illustrates how MPLS provides enhanced routing capabilities by supporting applications that require more than just destination-based forwarding. Assume that the routers in the network core 505 perform conventional, longest-match IP forwarding. If either Customer A 501 or Customer B 502 transmits a packet to Customer C 503, the packet follows Path 550 across the network core 505 because this is the shortest path computed by a traditional routing protocol, for instance, the Interior Gateway Protocol (IGP).

Suppose that the network administrator has been monitoring traffic statistics and needs to implement a policy to control congestion at Router B 520B. The policy would reduce congestion at Router B 520B by distributing the traffic load along different paths across the network. Traffic originating at Customer A 501 and destined for Customer C 503 would follow the IGP shortest path, Path 550. Traffic originating at Customer B 502 and destined for Customer C 503 would follow another path, Path 560. Using conventional IP routing, this policy cannot be implemented because all forwarding at Router A 520A is based on the packet's destination address.

However, if the routers in the network core 505 function as LSRs, a policy can be easily implemented to reduce congestion at LSR B 520B. The network administrator configures a LSP 1 550 to follow Path 550. The network administrator configures another LSP 2 560 to follow Path 560. Finally, the network administrator configures LER A 520A to put all traffic received from Customer A 501 and destined for Customer C 503 into LSP 1 550. Likewise, LER A 520A is configured to place all traffic received from Customer B 502 and destined for Customer C 503 into LSP 2 560. The ability to assign any Forwarding Equivalence Class (FEC) to a custom-tailored LSP gives the network administrator precise control of traffic as the traffic flows through a provider's network.

With careful planning, MPLS provides internet service providers a high level of control over traffic, resulting in a network that is more efficiently operated, supports more predictable service, and can offer the flexibility required to meet constantly changing customer expectations.

A standard has been proposed to the Institute of Electrical and Electronics Engineers, Inc. (IEEE) to further extend the specification of VLAN-aware MAC Bridges to enable a service provider organization to use a common infrastructure of Bridges and LANs to offer the equivalent of separate LANs, Bridged, or Virtual Bridged Local Area Networks to independent customer organizations. The proposed standard, IEEE P802.1ad, enables a service provider to use a Virtual Bridged Local Area Network to provide separate instances of the 802 MAC Service, MAC Internal, and Enhanced Internal Sublayer Services to multiple independent customers, in a manner that does not require cooperation among the customers and that requires a minimum of cooperation between the customers and the provider of the MAC Service, by further specifying the operation of Provider Bridges.

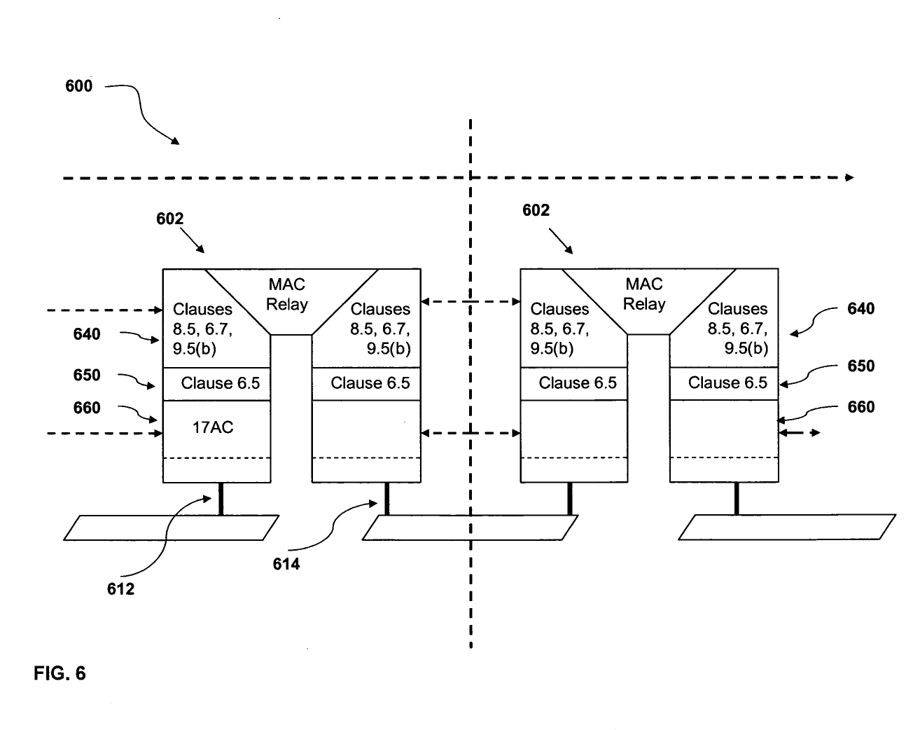

Referring now to FIG. 6, a diagram of an S-tagged service interface to a PBN defined by the proposed IEEE P802.1ad standard is shown. As illustrated in this figure, an example of a data frame consists of a Medium Access Control (MAC) entity 660, a MAC Convergent Function (MCF) 650, and a MAC Independent Function (MIF) 640. Segregation of data frames associated with different MAC Service instances is achieved by supporting each service instance with a separate Service VLAN (S-VLAN) and ensuring that: a) Provider Bridges 602 are configured such that no customer data frames are transmitted through a Provider Network Port 612 untagged (e.g. without a Service VLAN Tag (S-TAG)); b) no frames are accepted (e.g. received and relayed, from any customer system without first being subject to service instance selection); c) no frames are delivered to any customer system without explicit service instance identification; d) prior to transmission through a Provider Network Port 612, customer data frames are received through a Customer Network Port 614 within the provider network 600 that is exclusively accessed by a single customer and the S-VIDs of all frames received through that Customer Network Port 614 correspond to service instances that the customer is permitted to access; e) provider Bridges 602 and the S-VLAN component of each of the Provider Edge Bridges within the provider network can only be directly controlled by the service provider and customer equipment, including customer owned Provider Bridges 602, are not within the provider network 600 and are controlled by the customer; and f) only frames that have been transmitted through a Provider Network Port 612 can be received through other Provider Network Ports 612 within the provider network 600 (this S-tagged service interface to a PBN is described by the proposed IEEE P802.1ad standard).

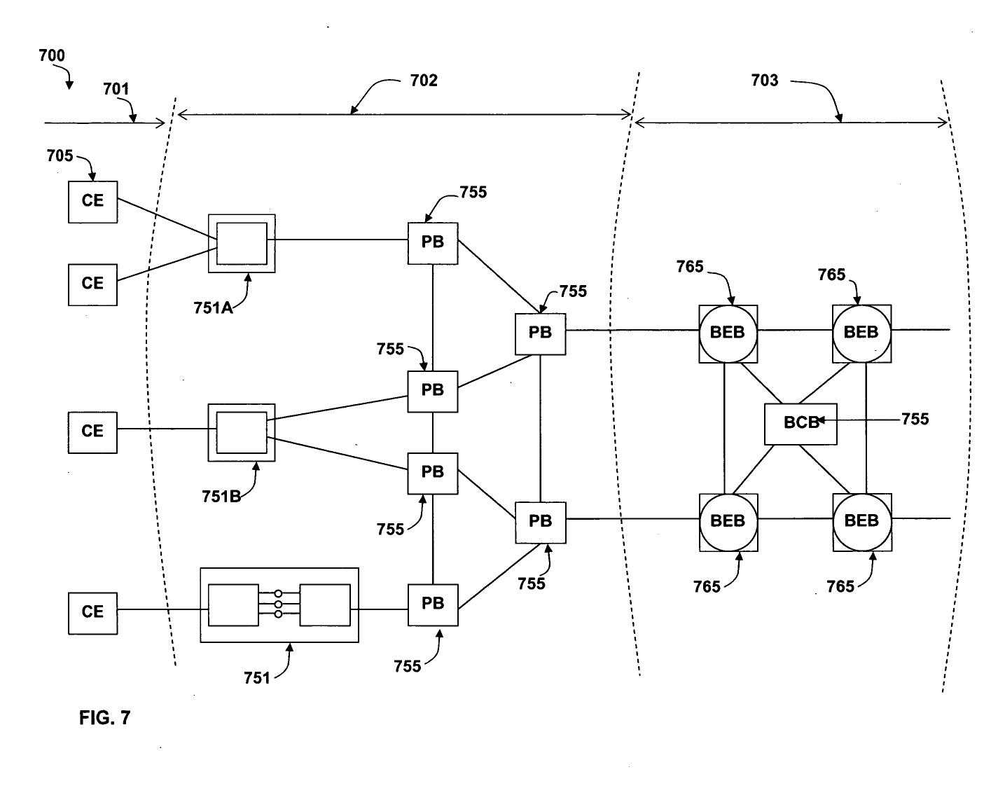

Now referring to FIG. 7, an example architecture of a PBN connected to a PBBN is illustrated. The architecture is also described by the proposed IEEE P802.1ah standard. The example network 700 is divided into three major regions: the Customer Equipment Region 701 which is owned by the customer and interfaces to the PBN 702; the PBN Region 702 which interfaces to the Customer Equipment 705 and to the Provider Backbone Bridged Network 703; and the Provider Backbone Bridged Network Region 703 which interfaces to multiple Provider Bridged Networks 702 allowing the Provider network 700 to scale over an entire metro area.

The Customer Equipment Region 701 and the Provider Bridged Network Region 702 are interconnected through S-VLAN aware Provider Bridges 751A or 751B and C-VLAN/S-VLAN aware Provider Edge Bridge 751. The Backbone Edge Bridges 765 (IEEE 802.1ah) and Backbone Core Bridges 755 (IEEE 802.1ad) are interconnected through Provider Ports as specified in IEEE 802.1ad. These interconnections can be part of a single Provider Network 700. The connections between Backbone Edge Bridges 765 are backbone LANs. The perimeter of the PBBN 703 is composed of Backbone Edge Bridges 765 which provide the interface ports for access to the PBBN 703. In the interior of the PBBN 703, PBBN 703 connects all the Backbone Edge Bridges 765 and the Backbone Core Bridges 755 through backbone LANs. In this embodiment, a single PBBN 703 is operated by a single Provider.

The Backbone Edge Bridges 765, the Backbone Core Bridges 755, and the LAN interconnecting the Backbone Edge Bridges 765 and the Backbone Core Bridges 755 are secured so that only the network provider operating the Provider Backbone Bridged Network 700 can manage the reception, transmission, and relay of frames between Provider backbone bridged network 703 and Provider Bridged Network 702. The network provider is required to meet bandwidth and service availability requirements at the Provider backbone bridged network Ports. The network provider also manages the arbitrary physical network topology of the Provider backbone bridged network 703 and the connectivity that the Provider backbone bridged network 703 provides to support segregated instances of the MAC Service. IEEE p802.1ah also proposes that application of the service VLAN ingress and egress rules at these Ports in support of service instance selection and identification ensures that frames cannot be transmitted or received on any service instance by any customer's equipment without prior agreement with the provider.

The active Multiple Spanning Tree Protocol (MSTP) topology of the Provider backbone bridged network Region 703 is separated from the active topology of the Provider bridged network Region 702. This is accomplished by isolating the MSTP Bridge Protocol Data Units (BPDUs) for each Provider Bridged Network 702 from the Provider backbone bridged network 703 at the Backbone Edge Bridges 765 which surround the perimeter of the Provider backbone bridged network 703. The Backbone Edge Bridges 765 also stop the propagation of MSTP BPDUs, used to support the active topology of the PBBN 703, into the Provider Bridge Region 702.

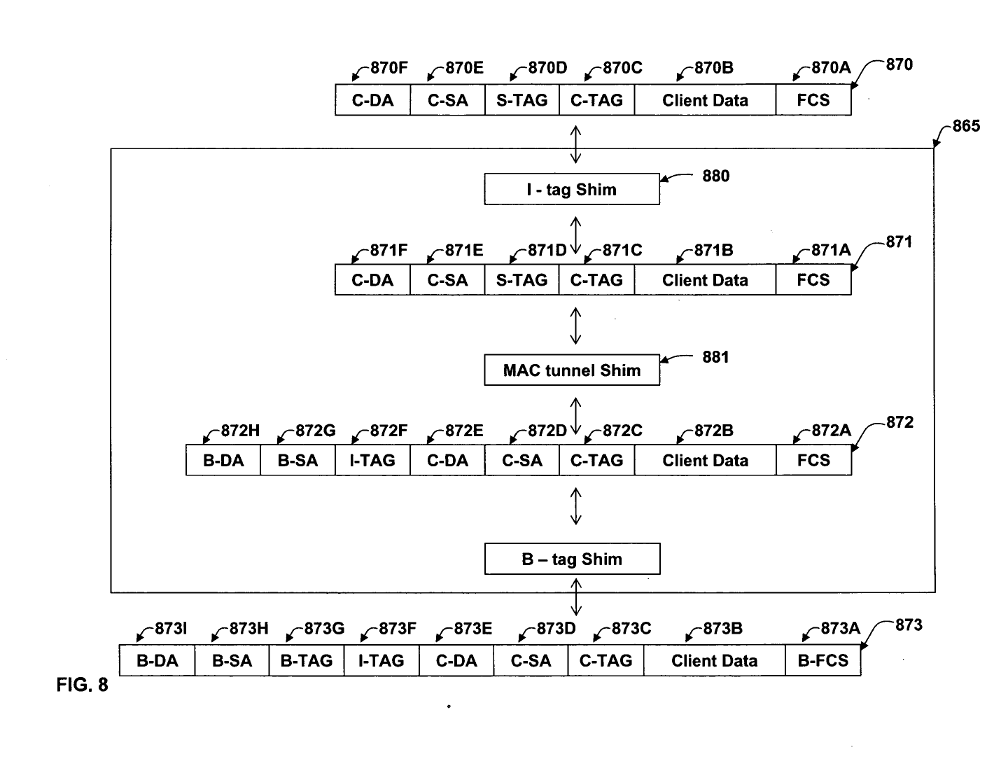

Now referring to FIG. 8, a flow scheme is described for the SVID/ISID mapping function, MAC encapsulation and de-encapsulation within the PBBN 703. This process is proposed by IEEE p802.1ah and modified by the Martini internet draft. In FIGS. 7 and 8, each MAC Service Instance is carried over the LANs connecting the Backbone Core Bridges 755 and the Provider Backbone Edge Bridges 865 (765 in FIG. 7) on a specific S-VLAN. The Provider Backbone Edge Bridges 865 preserve the S-VLAN over the backbone by mapping them onto an extended S-VLAN identifier (ISID). This operation is performed by using a Service VLAN identifier (S-VID) to I-SID mapping table which is provisioned by the Service Provider operating the PBBN 703. As shown in FIG. 8, a data frame is a S-TAG data frame 870 that includes a Frame Checking Sequence (FCS) 870A, Client Data 870B, a Customer VLAN Tag (C-TAG) 870C, a Service VLAN Tag (S-TAG) 870D, a Customer Source Address (C-SA) 870E and a Customer Destination Address (C-DA) 870F. When the S-TAG data frame 870 reaches the Backbone Edge Bridge 865, the I-TAG shim 880 is performed in that the S-TAG 870D is popped off and the I-TAG 871C is pushed on, thereby the S-TAG data frame 870 is mapped to I-TAG data frame 871.

Further, the Backbone Provider sets the mapping table on each Backbone Edge Bridge port. The Backbone Edge Bridge 865 performs a MAC tunnel shim 881 which encapsulates the service frame 871 with a new I-TAG 872F, B-DA 872G and B-SA 872H. Therefore the encapsulated frame includes the following fields: a FCS 872A, Client Data 872B, a (C-TAG) 872C, a C-SA 872D, and a C-DA 872E, the new I-TAG 872F, the new B-DA 872G, which is a MAC address identifying the PBBN 703 destination and the new B-SA, which is a MAC address identifying the PBBN 703 source. The frame 872 is further processed with B-tag shim 882 on which a B-TAG 873I is pushed on. The new frame 873 now includes a B-TAG 873I which is identical to an 802.1ad S-TAG (e.g. S-TAG 870D on the frame 870) and identifies the backbone tunnel. This new frame 873 is transmitted by the Backbone Edge Bridges 865 and by the Backbone Core Bridges 755. Since the format and Ether type of the backbone frames conform to IEEE 802.1ad, the frames may be forwarded by Backbone Core Bridges 755 until they reach the next Backbone Edge Bridge 865 where they are then de-encapsulated.

The Backbone Edge Bridge 865 then maps the frame onto a B-VLAN 850 (tunnel) which interconnects Backbone Edge Bridges 865. Backbone MAC addresses are used to identify the destination Backbone Edge Bridge 865. To perform the encapsulation and de-encapsulation of service frames Backbone Edge Bridges 865 must create a correlation table which maps customer MAC addresses to provider backbone MAC addresses. At startup the Backbone Edge Bridges 865 do not have the B-MACs or the C-MAC addresses. Both the B-MAC and C-MAC addresses are learned by the Backbone Edge Bridge 865.

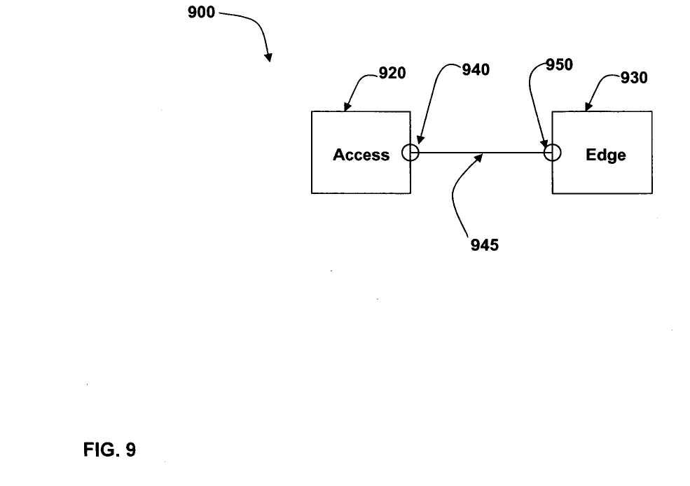

Referring now to FIG. 9, an SI mapping process at network boundaries is shown. In this figure, a WAN Access Bridge 920 and WAN edge device 930 are interconnected within a provider domain. At WAN Access Bridge 920, an SI is assigned an ISID unique within the provider domain (e.g. an SVID/ISID mapping 940 is performed). As a result, the traffic carries ISID 945 to reach WAN edge device 930. At the WAN edge device 930, a local identifier/ISID mapping 950 is performed and the traffic is pushed across the network connecting to WAN edge device 930. Alternatively, no mapping is performed and the traffic is pushed across the network connecting to WAN edge device 930 in which the ISID is also utilized as the local identifier. In either situation, the network connecting to WAN edge device 930 is not required to have knowledge of the local identifier values used by other networks within the provider domain.

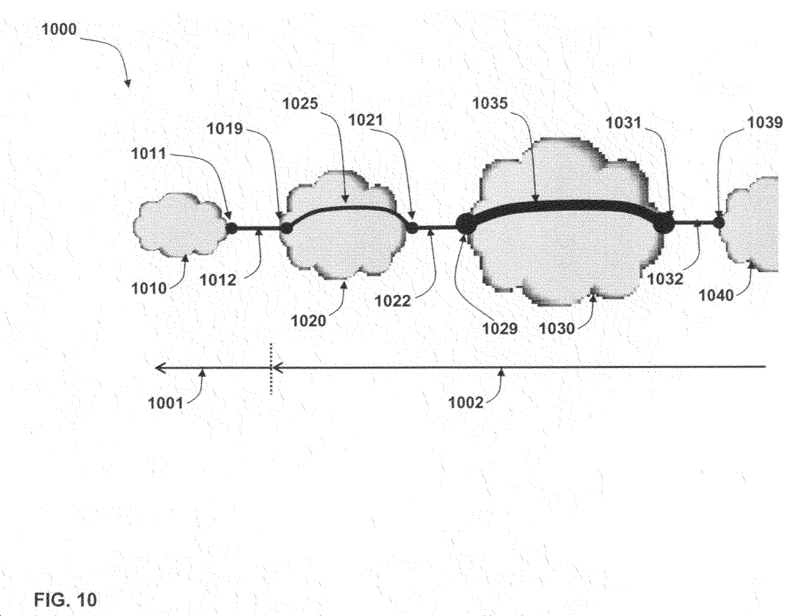

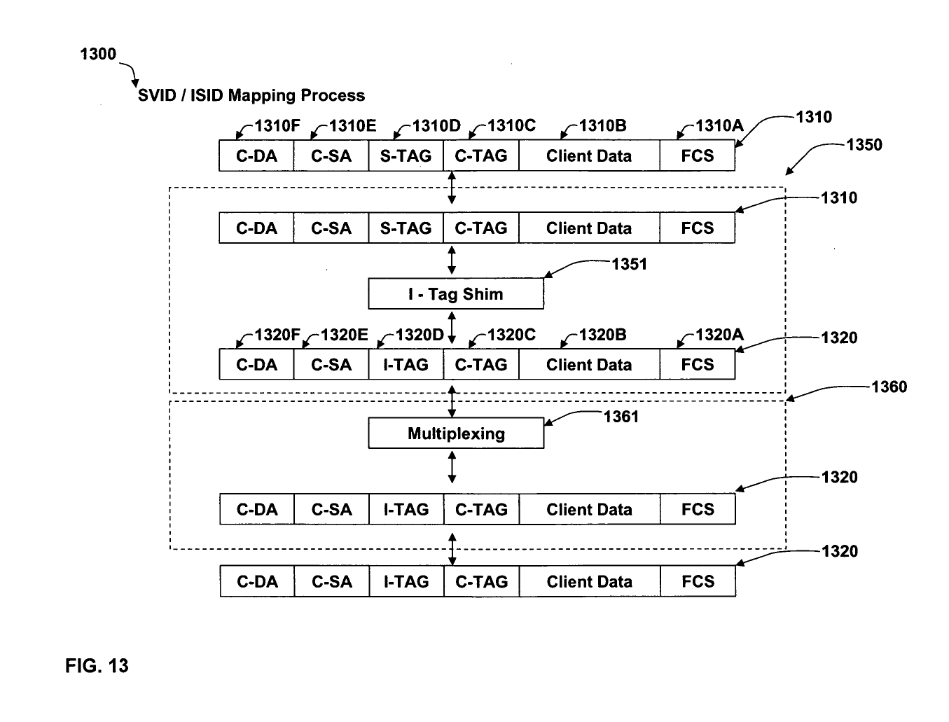

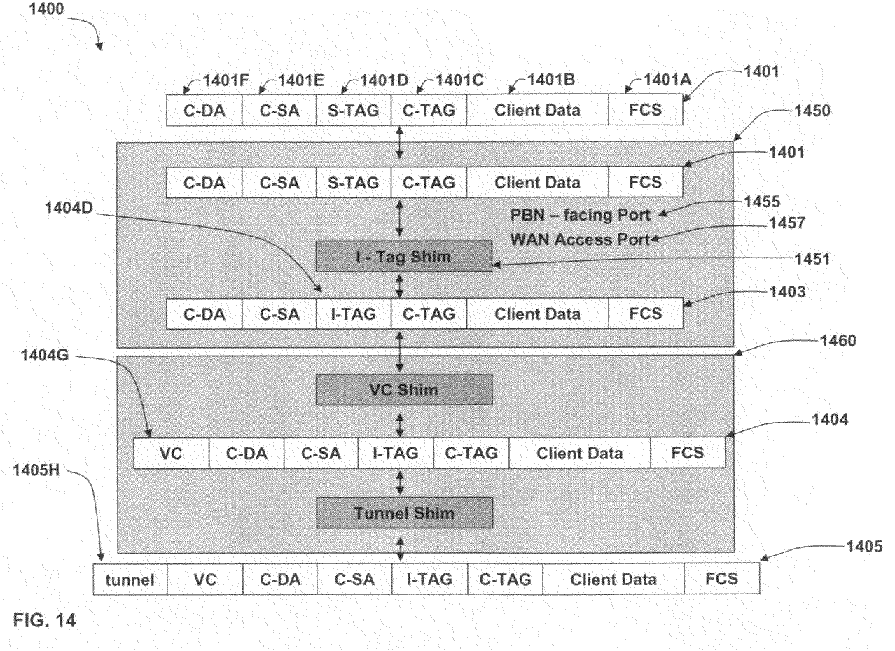

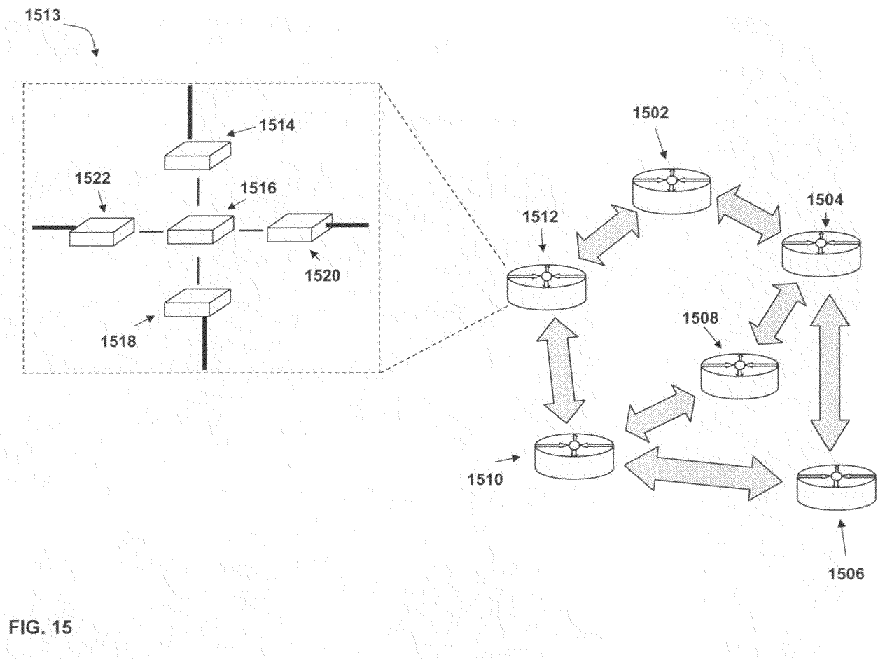

Referring now to FIG. 10, a schematic view for the interconnection of a PBN across a network (e.g. a MPLS network) is shown. FIG. 10 illustrates a customer region 1001 and a Service Provider Domain 1002. The Provider Edge Bridge 1019 receives data from a customer network 1010, then the data is pushed through a PBN 1020 as configured according to IEEE P802.1ad. Within the PBN 1020, the data carries an SVID value. When the data reaches the Provider Bridge 1021, a SVID/ISID mapping function (see FIGS. 13 and 14) is performed in the Provider Bridge 1021. An SI identifier unique within the Service Provider Domain 1002 is mapped onto the data and then the data is pushed to reach the network 1030. The data traffic arriving at the Backbone Edge Bridge 1029 of the network 1030 from the PBN 1020 carries the domain-global ISID value. At the Backbone Edge Bridge 1029, the ISID can be treated in different ways to be transported across the network 1030. In one scenario, the ISID serves as the local SI identifier within the network 1030 and traffic is transported across the network 1030. In this scenario, the mapping at the network 1030 is trivial because the global ISID also serves as the local SI identifier (see FIG. 13). In another scenario, the ISID is mapped to a VC value that locally identifies the SI within the network 1030. Further, the data is encapsulated to be transported through the network 1030.

In both scenarios, the result of the interconnection of the PBN 1020 across the network 1030 with SVID/ISID mapping is that the Provider Bridge 1021 of the PBN 1020 does not require knowledge of local identifiers lying outside the PBN 1020. Instead, the PBN 1020 maps between the local identifier SVID and the SI identifier global to the Service Provider Domain 1002. Similarly, the network 1030 does not require knowledge of local identifiers lying outside the network 1030. Instead, network 1030 either utilizes the global ISID as the local SI identifier or maps between the local identifier VC and the SI identifier global to the Service Provider Domain 1002.

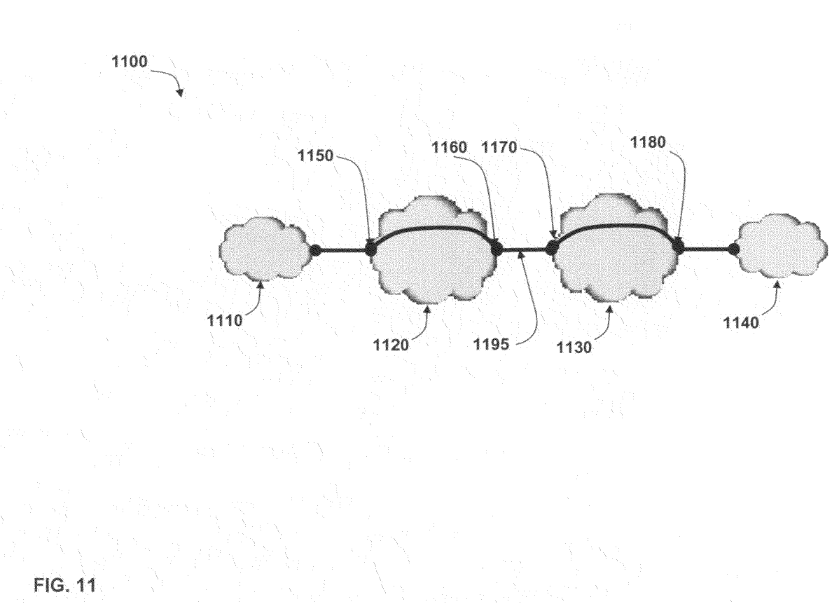

Now referring to FIG. 11, another embodiment of SVID/ISID mapping is described. As shown in FIG. 11, a provider domain is interconnected with Customer Network A 1110 and Customer Network B 1140. Within the provider domain, Provider Network A 1120 and Provider Network B 1130 are directly interconnected through Provider Bridge A 1160 and Provider Bridge B 1170. Provider Network A 1120 is connected with Customer Network A 1110 through Provider Edge Bridge A 1150 and Provider Network B 1130 is connected with Customer Network B 1140 through Provider Edge Bridge B 1180. When Provider Network A 1120 receives traffic from Customer Network A 1110 through Provider Edge Bridge A 1150, the traffic carrying a local SVID is pushed through Provider Network A 1120. When the traffic reaches Provider Bridge A 1160, the local SVID is mapped to an ISID unique within the provider domain. Then the traffic is pushed to reach Provider Bridge B 1170, where the local SVID of Provider Network B 1130 is mapped and the traffic is push across Provider Network B 1130, then further transported to Customer Network B 1140. The advantage of this mapping method is that Provider Network A 1120 is not required to have knowledge of the local SVID of Provider Network B 1130, nor is Provider Network B 1130 required to have knowledge of the local SVID Provider Network A 1120.

A person of the ordinary skill in the art will understand, this method can be utilized in a provider domain with different network interconnections. An ISID is assigned to be unique and global within the provider domain. Therefore, each network within the provider domain is not required to have knowledge of local identifier values used by other networks.

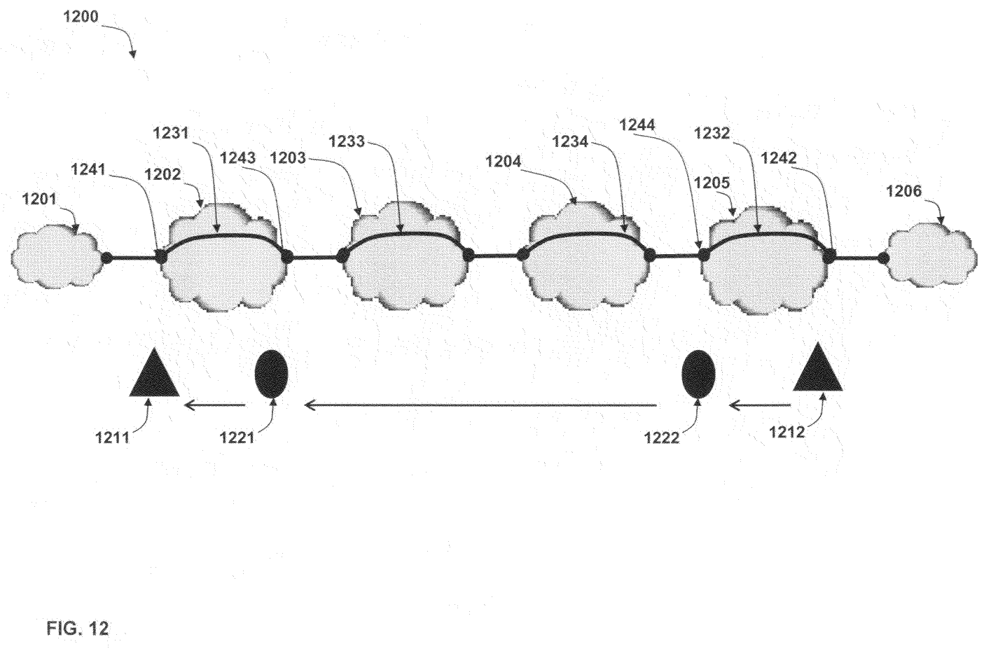

Now referring to FIG. 12, a schematic view for the interconnection of PBN networks across PBBN networks and implementation of the Connectivity Fault Management system at network boundaries is shown. In this figure, Customer Network A 1201 is connected to PBN A 1202 and Customer Network B 1206 is connected to PBN B 1205. PBN A 1202 is interconnected to PBBN A 1203 and PBN 1205 is interconnected to PBBN B 1204. Within this provider domain PBBN A 1203 and PBBN B 1204 are cross-connected. The configuration of the data traffic is that the SVID/ISID mapping function is performed at PBN Bridge A 1243. The SI value assigned at PBN Bridge A 1243 is carried in the traffic within PBBN A 1203, between PBBN A 1203 and PBBN B 1204, within PBBN B 1204, and then reaching PBN B bridge 1244. A person in the ordinary skill in the art will understand, the configuration of the data traffic in reverse direction from PBN B Bridge 1244 to PBN A Bridge 1243 is similar to that from PBN A Bridge 1243 to PBN B Bridge 1244.

Also shown in this figure, a CFM system is implemented in this provider domain. MEP A 1211 is configured within PBN A Edge Bridge 1241, MEP B 1212 is configured within PBN B Edge Bridge 1242, MIP A 1221 is configured within PBN A Bridge 1243, and MIP B 1222 is configured within PBN B Bridge 1244. In one embodiment, the assigned ISID value is provisioned in MEP A 1211 or MEP B 1212. As a result, MEP A 1211 or MEP B 1212 performs ISID value checking in comparison with the value discovered at either MIP A 1221 or MIP B 1222. When an ISID value received at MEP A 1211 or MEP B 1212 from MIP A 1221 or MIP B 1222 is identical to the ISID value originally provisioned in MEP A 1211 or MEP B 1212, the provider domain has a proper interconnection. When an ISID value received at MEP A 1211 or MEP B 1212 from MIP A 1221 or MIP B 1222 is not identical to ISID value originally provisioned in MEP A 1211 or MEP B 1212, the system will indicate a cross-connection error within the provider domain. In another embodiment, the assigned ISID value is not provisioned in MEP A 1211 or MEP B 1212. However, the verification process among MEP A 1211 or MEP B 1212 and MIP A 1221 or MIP B 1222 is still capable of detecting whether the ISID values is consistent in the traffic within the cross-connection between PBBN A 1203 and PBBN B 1204.

A person in the ordinary skill in the art will understand, the implementation of the CFM system on verification of unique ISID value across network traffic is applicable to all configuration of internetworking in a provider domain.

Another embodiment of the invention includes a novel method of mapping between an SVID locally identifying a Service Instance with respect to a PBN and a Martini VC locally identifying the Service Instance with respect to an MPLS Wide Area Network (WAN). A mapping between local SVID and global ISID is performed at the Provider Bridge. A translation between Martini VC and ISID is performed at the LER. Thus, the PBN need not be aware of the VC used locally by the MPLS network and the MPLS network need not have awareness of the SVID used locally by the PBN. Only global identifiers cross network boundaries. Further, use of a mapping table at the LER may be avoided by restricting use of the ISID to the low-order 20-bits, making it identical in size and format to the MPLS Label. In this case, the mapping between ISID and VC, performed at the LER, is trivial and requires no mapping table. An example of this method is shown in FIG. 13. In this figure, the SVID/ISID mapping function is shown within a Provider Bridge of a PBN and the multiplexing function within a PBBN. As shown, a data frame is a S-TAG data frame 1301 comprising Frame Checking Sequence (FCS) 1301A, Client Data 1301B, Customer VLAN Tag (C-TAG) 1301C, Service VLAN Tag (S-TAG) 1301D, Customer Source Address (C-SA) 1301E and Customer Destination Address (C-DA) 1301F. When the S-TAG data frame 1301 reaches the Provider Bridge 1321 as shown in FIG. 4, the SVID/ISID mapping function is performed on the interface of the PBN-facing port 1355 and the WAN Access Port 1357. The I-TAG shim is performed in that the S-TAG 1301D is popped off and the I-TAG 1303D is pushed on, thereby the S-TAG data frame 1301 is mapped to I-TAG data frame 1303. Upon completion of the SVID/ISID mapping function, the I-TAG data frame 1303 is pushed to reach the PBBN 1360 (also see FIG. 10). Within the PBBN 1360, no mapping function is performed. Rather, the I-TAG data frame 1303 is multiplexed with other data frame carrying the ISID and transported across the PBBN 1360. The PBBN 1360 uses the ISID as local identifier for transporting the I-TAG data frame 1303.

Now referring to FIG. 14, the SVID/ISID mapping function is shown within a Provider Bridge of a PBN and the ISID/VC mapping function within a PBBN. As shown in FIG. 14, a data frame is a S-TAG data frame 1401 comprising Frame Checking Sequence (FCS) 1401A, Client Data 1401B, Customer VLAN Tag (C-TAG) 1401C, Service VLAN Tag (S-TAG) 1401D, Customer Source Address (C-SA) 1401E, and Customer Destination Address (C-DA) 1401F. When the S-TAG data frame 1401 reaches the Provider Bridge 1421 as shown in FIG. 10, the SVID/ISID mapping function is performed on the interface of the PBN-facing port 1455 and the WAN Access Port 1457. The I-TAG shim is performed in that the S-TAG 1401D is popped off and the I-TAG 1403D is pushed on, thereby the S-TAG data frame 1401 is mapped to I-TAG data frame 1403. Upon completion of the SVID/ISID mapping function, the I-TAG data frame 1403 is pushed to reach the PBBN 1460 (see FIG. 10). Within the PBBN 1460, an VC shim is performed in which an VC value is pushed on the I-TAG data frame 1403, and then the VC-I-TAG data frame 1404 is encapsulated to across the PBBN 1460.

FIG. 15 is a diagram illustrating an example embodiment of the invention. In this embodiment, six network devices, for example switches, are interconnected. Specifically, switch 1502 is connected to switch 1504 and switch 1512. In turn, switch 1504 is connected to switch 1506 and switch 1508. Moreover, switch 1506 is connected to switch 1510 which also connects to switch 1508 and switch 1512. In this embodiment, all of the switches 1502, 1504, 1506, 1508, 1510 and 1512 are compliant with the IEEE 802.1 standards. Additionally, details of the makeup of switch 1512 are shown in cutout 1513 of FIG. 15. As shown, switch 1512 is constructed with components of a standard 801.1ah Provider Backbone Bridging Network enclosed in a chassis. Similar to the Provider Backbone Bridged Network 703 shown in FIG. 7, Switch 1512 includes four Backbone Edge Bridges (BEBs) 1514, 1520, 1518, and 1522 connected to a Backbone Core Bridge (BCB) 1516. Each of the BEBs 1514, 1520, 1518, and 1522 include ports that are compliant with the I-TAG interface specified by the 802.1ah standard. In addition, BCB 1516 is also compliant with the 802.1ad standard. In this embodiment, all of the switches 1502, 1504, 1506, 1508, 1510 and 1512 are built similarly and can be used to support edge-to-edge connections having the property that resources, such as capacity, are reserved along the path of each connection. On the link between switches, each connection is distinguished by an ISID value. At each switch, inbound traffic is identified with a connection by its ISID value and inbound port. Moreover, outbound traffic is sent on a port or set of ports associated with the connection (excluding the inbound port). Additionally, the frame carries an I-TAG associated with the connection and with the outbound port. This method of “identifier swapping” is a well-known technique for forwarding data on connections. It is used in the forwarding of traffic on MPLS paths and ATM connections. However, the application of this technique to the ISID, known as “I-switching” or “ISID swapping”, is novel. For example, if the path between 1502 and 1512 used 222 as an ISID, and the path between 1512 and 1510 used 333 as an ISID, data originating from 1502 destined to 1510 would get the ISID switched from 222 to 333 at switch 1512. Another example is if the path between 1510 and 1506 used 123 as an ISID and the path between 1506 and 1504 used 456 as an ISID, data originating at 1510 destined for 1504 would get the ISID switched from 123 to 456 at switch 1506.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of transporting data within a network of a plurality of IEEE 802.1 compliant devices, the method comprising:
providing a first service instance identifier for data at one of the plurality of devices; and
switching the first service instance identifier for the data at a second of the plurality of devices to a second service instance identifier, wherein the plurality of compliant devices include at one backbone core bridge and at least two backbone edge bridges.

2. The method of claim 1, wherein the network is an Ethernet network.

3. The method of claim 1, wherein the network is an Wide area network.

4. The method of claim 1, wherein the network is an Metropolitan network.

5. The method of claim 1, wherein the network provides both connectionless and connection oriented communications.
